(19) United States
(12) Patent Application Publication
(10) Pub. No.: US 2010/0303320 A1
(43) Pub. Date: Dec. 2, 2010

(54) SYSTEMS, METHODS AND MACHINE READABLE PROGRAMS FOR ENHANCED FAT/WATER SEPARATION IN MAGNETIC RESONANCE IMAGING

(76) Inventors: Peter B. Roemer, Wilmington, MA (US); Yuan Cheng, Wilmington, MA (US)

Correspondence Address: General Electric Company;GE Global Patent Operation, 2 Corporate Drive, Suite 648, Shelton, CT, 06484, US

(21) Appl. No.: 12/741,981

(22) PCT Filed: Nov. 7, 2008
(86) PCT No.: PCT/US08/12567

§ 371 Date: Aug. 19, 2010

Related U.S. Application Data
(60) Provisional application No. 60/986,014, filed on Nov. 7, 2007.

(51) Int. Cl. G06K 9/00

(52) U.S. Cl. 382/131

(57) ABSTRACT

Methods, systems and machine readable programs are disclosed herein for providing improved magnetic resonance images, particularly with respect to fat and water separation.

### CROSS-REFERENCE TO RELATED APPLICATIONS

This application claims the benefit of priority to U.S. patent application Ser. No. 60/986,014 filed Nov. 7, 2007, which application is incorporated herein by reference in its entirety.

### BACKGROUND OF THE INVENTION

1. Field of the Invention

The present invention relates to methods, systems and software programs for performing medical imaging. Particularly, the present invention is directed to systems, methods and software programs for providing improved fat and water separation in Magnetic Resonance Imaging (“MRI”).

2. Description of Related Art

It is highly desirable in Musculoskeletal (MSK) MRI imaging to suppress the bright fat in the images so as not to obscure regions of water which can be used to aid in a diagnosis. Fat suppression techniques generally exploit the chemical shift frequency difference between the protons in fat and water. This chemical shift is typically about 3.5 ppm which corresponds to a frequency separation of 150 Hz for magnetic fields of 1.0 Tesla.

Standard chemical shift fat suppression methods generally apply a frequency selective radio frequency pulse to excite only fat. A gradient spoiler is then applied in one or more spatial directions to destroy the fat signal in the image. The water is then excited with a second RF pulse and the resultant image of the water collected. This method requires a relatively uniform magnetic field and works for field inhomogeneities approaching 3.5 ppm.

An alternative method of fat suppression separates the fat and water by using the phase difference of 2 or more acquired images. The method was first proposed by Dixon (Simple Proton Spectroscopic Imaging; Radiology 1984; 153:189-194) and later enhanced to 3 points by Glover et. al. (Three Point Dixon Technique for True Water/fat Decomposition With B₀ Field Inhomogeneity Correction; Magn. Reson. Med. 1991; 18:371-383). The methods exploit the fact that if fat and water are both excited at the same time, the chemical shift causes a phase difference between fat and water after some time delay. Assuming no error due to field inhomogeneities, two images are required to separate fat and water. One image can be acquired with a time delay so that fat and water are in phase and a second image can be acquired with a time delay so fat and water are 180 degrees out-of-phase. Subtraction of the images and addition of the images can then be used to create fat and water images respectively.

In general, the separation of the fat and water using a phase sensitive method requires the collection of three pieces of information corresponding to the three unknowns of fat, water and the magnetic field homogeneity, hence the introduction of the third point by Glover et. al. The advantage of a three point phase sensitive method over frequency selective methods is the ability to correct for field inhomogeneity during reconstruction of the images. Because of the ability to correct the field inhomogeneity after the fact, this technique, in principle, can operate effectively in magnetic fields that are more inhomogeneous. The three point method requires phase unwrapping due to frequency aliasing of the fat and water. The method breaks down when the inhomogeneities are so large that the signal loss due to de-phasing within a pixel destroys the net signal from that pixel. This happens in locations where the field inhomogeneity is changing rapidly which in turn occurs at the edge of the image or near metal implants.

Xiang et al. (Two-Point Water-Fat Imaging with Partially-Opposed-Phase (POP) acquisition: An Asymmetric Dixon Method; Magn. Reson. Med. 2006; 56:572-584) acquires two FSE image sets, one in phase and one partially out of phase. This results in two possible phase candidates for each pixel. By using low pass filters, comparing the phase of adjacent pixels and iterative corrections, a method to resolve the ambiguity between the two phase candidates is described. This method assumes and exploits the notion that the phase error between adjacent pixels due to inhomogeneity is small. It works on many data sets but attempts to apply this algorithm to data collected by Applicant actually resulted in many images with incorrect phase errors in areas of rapidly changing magnetic field and/or in areas of uniform fat or water.

Reeder et. al. (Iterative Decomposition of Water and Fat with Echo Asymmetry and Least Squares Estimation (IDEAL): Application with Fast Spin-Echo Imaging; Magn. Reson. Med. 2005; 54:636-644) describes a method where FSE images are acquired using 3 echoes that are partially in phase. This method requires 3 FSE acquisitions instead of 2 as described here.

Yu et. al. (Field Map Estimation with a Region Growing Scheme for Iterative 3-point Water-Fat Decomposition; Magn. Reson. Med. 2005; 54:1032-1039) describes a field estimation method using three point FSE data similar to Reeder's but utilizes a region growing scheme with iterative correction. Attempts to apply this algorithm to 2-point FSE data have similar problems as Xiang's approach.

As can be seen from the above, such conventional methods and systems, while useful in certain contexts, suffer from certain inherent deficiencies. The present invention provides a solution for these and other problems, as described herein.

### SUMMARY OF THE INVENTION

The purpose and advantages of the present invention will be set forth in and become apparent from the description that follows. Additional advantages of the invention will be realized and attained by the methods and systems particularly pointed out in the written description hereof, as well as from the appended drawings.

To achieve these and other advantages and in accordance with the purpose of the invention, as embodied herein, the invention includes methods, systems and software programs for acquiring and reconstructing fat/water separated Magnetic Resonance images. In accordance with one embodiment, this is performed using a Fast Spin Echo (“FSE”) sequence. This accordingly allows one to obtain the T2 and/or proton density weighted contrast of the fast spin echo technique while at the same time creating separate images of the fat, water or the combined fat/water image.

In accordance with a preferred embodiment, the method, system and software programs of the invention may employ a set of reference image scans that do not constitute part of the final image to obtain a map of the magnetic field inhomogeneity. Two FSE image scans may be taken where the spin echo and gradient echoes are offset in time resulting in a phase difference of fat and water in the image. The phase difference due to field inhomogeneities may then be removed using information from the reference scans. The remaining phase difference is due to the fat-water chemical shift. The two images may then be algebraically adjusted on a pixel by pixel basis to create separate images of the fat and water.

In accordance with one embodiment, a method of collecting magnetic resonance images is provided. The method includes collecting at least one reference scan with respect to a region of interest and collecting at least one imaging scan with respect to the region of interest. The method further includes analyzing the at least one reference scan to determine the inhomogeneity of the transmit field, and adjusting the at least one imaging scan to account for the inhomogeneity of the transmit field to form a final image.

In accordance with a further embodiment, a plurality of reference scans may be collected with respect to the region of interest, and a plurality of imaging scans may be collected with respect to the region of interest. Further, the plurality of reference scans may be analyzed to determine the inhomogeneity of the transmit field, and the imaging scans may be adjusted to account for inhomogeneity of the transmit field to form the final image.

In accordance with still a further embodiment, the plurality of reference scans are collected prior to the plurality of imaging scans, and the plurality of reference scans do not constitute part of the final image. The reference images may be used to obtain a map of transmit field inhomogeneity. The phase difference due to field inhomogeneities are preferably removed using information from the reference scans. A first reference scan may be performed with the gradient echo and the spin echo occurring at substantially the same time. A second reference scan may also be performed with the gradient echo and the spin echo occurring at substantially the same time. The imaging scans are preferably used to create separate images of fat and water in the region of interest. The separate images of fat and water may be created by adjusting the imaging scans on a pixel by pixel basis.

In accordance with a further aspect of the invention, the plurality of imaging scans may be collected using a fast spin echo sequence. In accordance with still a further aspect, a first imaging scan may be collected with fat and water in-phase, and a second image is collected with fat and water out of phase by a predetermined amount. An image relating to the first imaging scan may be created by collecting the gradient echo at the spin echo time when the chemical shift between the fat and water are substantially refocused. If desired, an image relating to the second imaging scan may be created by collecting the gradient echo at a time misaligning to the spin echo. Preferably, the spin echo and gradient echo are chosen such that fat and water are separated in phase by about 360 degrees.

In accordance with a further aspect, the images are collected in a background magnetic field having a strength between about 0.5 T and about 7.0 T. Preferably, the images are collected in a background magnetic field between about 1.5 T and about 5.0 T. If desired, the images can be collected in a background magnetic field between about 3.0 T and about 4.0 T.

In accordance with still a further aspect, the reference scans may be processed in parallel with the imaging scans. The reference scans and imaging scans may use the same timing or different timing. The reference scans and imaging scans do not need to use the same number of phase encode steps, but may if desired. The reference scans and imaging scans do not need to use the same echo times, but may if desired. In accordance with one aspect, the computed phase difference between two images may be obtained by way of the reference scans is used to create a phase map image.

In further accordance with the invention, a method of performing phase unwrapping is provided. The method includes identifying a plurality of pixels in a slice containing tissue to be unwrapped by distinguishing pixels containing substantially no tissue from pixels containing tissue. The method may further include sorting the identified pixels in the slice into groups of pixels, and computing the numbers of border pixels for each of the groups of pixels. The method may still further include iteratively combining the groups of pixels in the slice, adjusting the phase of pixels in groups furthest from the image center to comport with the phase of pixels proximate the image center, and computing the average phase difference between locations in adjacent slices, beginning from the center slice and working outward in opposite slice directions. The method may also include iteratively adjusting the phase of points in slices furthest from center slice to match average phase difference between slices.

Preferably, pixels containing substantially no tissue may be distinguished from pixels containing tissue by setting a threshold on image intensity. The sorting step may include sorting the identified pixels in the slice into groups of pixels based on at least one of (i) the uniformity of magnetic field in the region of the pixel, and (ii) the strength of signal to noise ratio in the region of the pixel. The sorting step may include sorting the identified pixels in the slice into groups of continuously connected pixels. The size of each group of continuously connected pixels and the number of pixels in each such group above an intensity threshold may be computed. If desired, pixels are not processed in groups where each pixel in the group is below the intensity threshold. The threshold may be increased if the number of groups of pixels exceeds a preset value. In accordance with one embodiment, the phase difference between adjacent pixels is smaller than a predetermined step value.

In accordance with a further aspect, border pixels may include pixels wherein one of the nearest 8 pixels to the subject pixel is from an adjacent group of pixels. Pairs of the pixel groups with the largest number of border pixels may be combined prior to other pairs of pixel groups. Moreover, pixels associated with substantially isolated groups of pixels may be analyzed to determine the number of tissue-containing pixels that are within a predetermined distance from the pixels associated with the substantially isolated groups. If desired, the predetermined distance may be a dimension relating to about 20% of the image field of view. In accordance with a further aspect, the substantially isolated groups of pixels may be iteratively combined. In that case, isolated pixels with the greatest number of neighboring pixels are preferably combined first.

The invention also provides a system for collecting magnetic resonance images. The system includes means for collecting at least one reference scan with respect to a region of interest and means for collecting at least one imaging scan with respect to the region of interest. The system further includes means for analyzing the at least one reference scan to determine the inhomogeneity of the transmit field, and means for adjusting the at least one imaging scan to account for the inhomogeneity of the transmit field to form a final image. The invention also provides a system for collecting magnetic resonance images, comprising means for collecting a plurality of reference scans with respect to a region of interest and means for collecting a plurality of imaging scans with respect to the region of interest. The system also includes means for analyzing the plurality of reference scans to determine the inhomogeneity of the transmit field, and means for adjusting the imaging scans to account for inhomogeneity of the transmit field to form a final image.

The invention also provides a system for performing phase unwrapping. The system includes means for identifying a plurality of pixels in a slice containing tissue to be unwrapped by distinguishing pixels containing substantially no tissue from pixels containing tissue. The system further includes means for sorting the identified pixels in the slice into groups of pixels and means for computing the numbers of border pixels for each of the groups of pixels, as well as means for iteratively combining the groups of pixels in the slice. The system also includes means for adjusting the phase of pixels in groups furthest from the image center to comport with the phase of pixels proximate the image center and means for computing the average phase difference between locations in adjacent slices, beginning from the center slice and working outward in opposite slice directions. The system further includes means for iteratively adjusting the phase of points in slices furthest from center slice to match average phase difference between slices.

The systems of the invention described above can be provided with any means for carrying out any method of the invention or aspect thereof. The invention also provides machine readable programs on a computer readable medium containing instructions for controlling a system for collecting and processing magnetic resonance images. The machine readable programs can be provided with any suitable means and computer code segments for carrying out any method of the invention or aspect thereof.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 depicts a Fast Spin Echo Sequence showing two excitations and the first 2nd echoes. In the first excitation the spin echo and gradient echo coincide in time. In the second excitation the readout, phase and data acquisition window (Rx) are shifted in time by echo shift.

FIG. 2(A) depicts a sagittal phase map image of the knee before phase unwrapping and FIG. 2(B) depicts the corresponding unwrapped map.

FIG. 3(A) depicts an exemplary unwrapped phase map using a simple search algorithm and FIG. 3(B) depicts an unwrapped phase map using an improved exemplary algorithm in accordance with the invention.

FIG. 4(A) depicts the 0 degree in phase reference image magnitude and FIG. 4(B) depicts the 0 degree in phase reference image phase for an exemplary 128×128 matrix.

FIG. 5 is an exemplary 360 degree in-phase reference image depicting magnitude (5(A)) and phase (5(B)). Fat and water are aliased with the remaining phase error caused by the inhomogeneity. The loss of signal on the top and bottom of the image is a result of the rapidly changing magnetic field causing dephasing of the signal within a pixel. The matrix size is 128×128.

FIG. 6 depicts exemplary in-phase FSE data magnitude (6(A)) and phase (6(B)). Like the reference images, the in-phase data does not show significant signal or phase change from the magnet inhomogeneity.

FIG. 7 depicts out-of-phase FSE data separated by 135 degrees between fat and water. FIG. 7(A) depicts magnitude and FIG. 7(B) depicts phase. The phase of the images shows the effects of the homogeneity as well as a difference phase between fat and water. There is signal loss at the top and bottom of the image but to the same extent as with the reference images owing to the smaller angle of 135 degrees between fat and water.

FIG. 8 depicts exemplary Fat (FIG. 8(A)) and Water (FIG. 8(B)) reconstructed images. The imaging field of view is 160 mm.

FIG. 9 depicts exemplary Fat (FIG. 9(A)) and Water (FIG. 9(B)) reconstructed images with a 14 cm diameter axial by 16 cm diameter ellipsoidal image mask. The imaging field of view is 160 mm.

### DETAILED DESCRIPTION OF THE PREFERRED EMBODIMENT

Reference will now be made in detail to the present preferred embodiments of the invention, examples of which are illustrated in the accompanying drawings. The method and corresponding steps of the invention will be described in conjunction with the detailed description of the system.

Embodiments of the systems, methods, and software programs presented herein improve upon existing techniques of fat/water separation by characterizing the magnetic field inhomogeneity using an imaging acquisition as a separate step from the FSE image acquisition. Moreover, if desired, a novel phase unwrapping technique is also embodied herein that may be used to complement the characterization of the magnetic field inhomogeneity. Such embodiments maintain the advantages of two point partial in-phase/out-of-phase FSE image scans while resulting in a more robust determination of the phase error introduced by the magnetic inhomogeneity.

As will be appreciated by those of skill in the art, the phase reference information that is used to characterize the magnetic field inhomogeneity may be collected in advance of the image information. The processing of the reference images can be time consuming and collecting all the information in advance of the FSE scans allows their processing in parallel with the FSE scans, which is highly advantageous.

As will be further appreciated, the reference scans and the FSE scans are not constrained to utilize the exact same timing, number of phase encode steps and echo times. This allows a greater flexibility in the choice of scan parameters for both scans. For example the TR and TE of the reference scans can be kept very short minimizing imaging time.

Furthermore, the reference scans may be performed such that fat and water are aliased on top of each other simplifying the phase unwrapping method. Using FSE scan with fat and water aliased 360 degrees would result in excessive spacing between echoes causing large echo spacing and lost contrast and signal-to-noise.

In accordance with another aspect of the invention, novel techniques for unwrapping the phase are provided. In accordance with particular embodiments, novel grouping techniques are provided which eliminate problems with isolated pixel errors by grouping pixels before unwrapping is described. These algorithms are not sensitive to single pixel phase errors and are robust in the presence of flow and motion.

### Example

### Fat-Water Separation

For purposes of illustration, and not limitation, as embodied herein, exemplary techniques are provided herein wherein two sets of reference images and two sets of FSE images are collected. The reference images are preferably collected first and processed during the collection of the FSE image data. The reference images are used to correct the phase errors introduced by the magnetic field inhomogeneity. The corrected FSE images are then processed to produce a fat and a water image. Following is more detail about this processing.

Fat and Water Image Determination from FSE Images

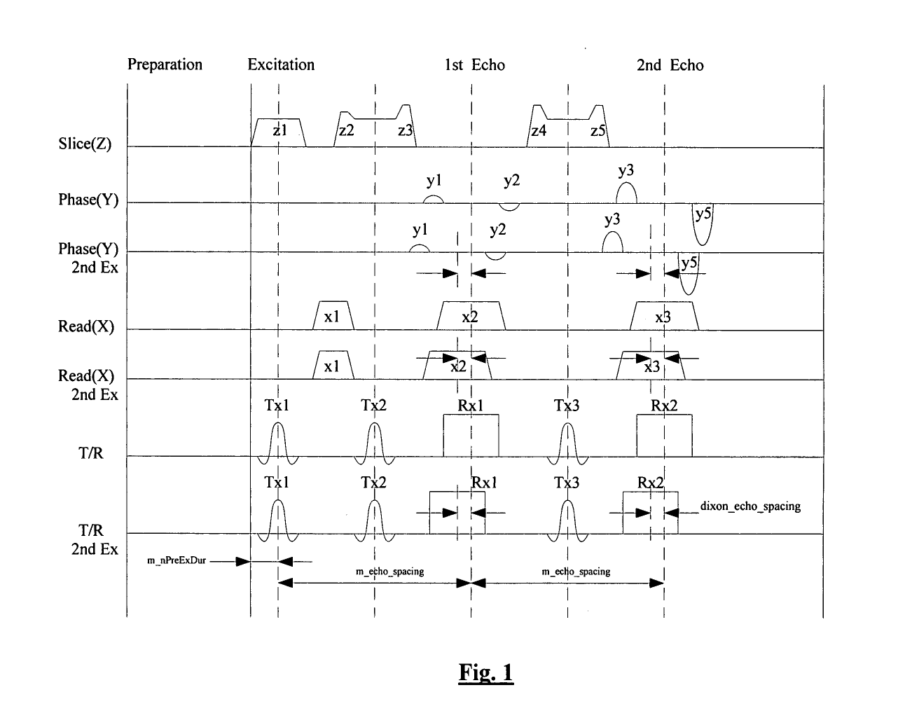

The first FSE image, I₁, is collected with fat and water in-phase and the second image, I₂, is collected with fat and water out-of-phase by a designated amount α. I₁ is created by collecting the gradient echo at the spin echo time when the chemical shift between the fat and water are refocused and the second FSE image I₂ is created by purposely collecting the gradient echo at a time misaligning to the spin echo. FIG. 1 depicts exemplary pulse sequence waveforms. The resultant images on a pixel by pixel basis are then given by:

I₁=(W+F)e^{iφ}^{₀} (1)

I₂=(W+Fe^{iα})e^{iφ}^{₀}e^{iφ}^{ₘ} (2)

wherein I₁ and I₂ are complex images, F is the quantity of fat, W is the quantity of water, φ₀ is a constant phase error due to electronics, φₘ is the phase error due to the magnetic inhomogeneity and α is the phase error due to the chemical shift frequency difference of fat and water. The phase error due to the magnetic field inhomogeneity and the chemical shift is related to the echo time offset between the gradient and spin echo according to:

φₘ=2π(γB₀−f₀)(Te2−Te1) (3)

α=2πσ(Te2−Te1) (4)

wherein σ is the chemical shift in Hz between fat and water, Bo is the magnetic field as a function of space in Tesla, f₀ is the spectrometer center frequency in Hz, γ is the proton gyromagnetic ratio of protons in Hz/Tesla, Te1 is the in-phase echo time in seconds and Te2 is the out-of-phase echo time in seconds. The difference in the echo times is the echo shift as shown in FIG. 1.

To compute the fat and water images from the above collected FSE data, the effects of the phase error caused by the magnetic field homogeneity are removed. Following, for example, the nomenclature in Xiang (referenced above) and multiplying Equation (1) e^{-iφ}^{₀} and Equation (2) by e^{-iφ}^{₀} e^{-iφ}^{ₘ}, we define 2 new quantities, C1 and C2, the phase corrected FSE images:

C₁≡I₁e^{-iφ}^{₀}=(W+F) (5)

C₂≡I₂e^{-iφ}^{₀}e^{-φ}ₘ=(W+Fe^{iα}) (6)

wherein C1 is purely real and C2 is complex. Equation (5) and (6) are two unknowns with three equations as described in Xiang and given by:

$$[ \begin{matrix}{C}_{1} \\ Re ( {C}_{2} ) \\ Im ( {C}_{2} )\end{matrix} ] = [ \begin{matrix}1 & 1 \\ 1 & cos ( α ) \\ 0 & sin ( α )\end{matrix} ] [ \begin{matrix}W \\ F\end{matrix} ] \qquad ( 7 )$$

Solving this set of overdetermined equations in a least square sense as in Xiang yields the fat and water images in terms of the corrected FSE images:

$$[ \begin{matrix}W \\ F\end{matrix} ] = \frac{1}{3 + cos ( α )} [ \begin{matrix}1 & 2 + cos ( α ) & \frac{sin ( α ) ( 1 + cos ( α )}{cos ( α ) - 1} \\ 1 & - 1 & \frac{- 2 sin ( α )}{cos ( α ) - 1}\end{matrix} ] [ \begin{matrix}{C}_{1} \\ Re ( {C}_{2} ) \\ Im ( {C}_{2} )\end{matrix} ] \qquad ( 8 )$$

To construct an in phase image and out of phase image, one can take the sum and difference of the fat and water images. This can result in image artifacts at the edges where the phase within a pixel is so twisted that its precise value is in error. An alternative formulation, which does not appear to be prone to artifacts, uses as a starting point the two potential fat and water candidates using magnitude information only. These components are computed as in Xiang. The solutions are denoted as B for Big and S for Small chemical components:

$$\begin{matrix}B = \frac{\vert {I}_{1} \vert}{2} + \frac{1}{2} \sqrt{\frac{2 {\vert {I}_{1} \vert}^{2} - {\vert {I}_{2} \vert}^{2} ( 1 + cos ( α ) )}{1 - cos ( α )}} & ( 9 ) \\ S = \frac{\vert {I}_{1} \vert}{2} - \frac{1}{2} \sqrt{\frac{2 {\vert {I}_{1} \vert}^{2} - {\vert {I}_{2} \vert}^{2} ( 1 + cos ( α ) )}{1 - cos ( α )}} & ( 10 )\end{matrix}$$

The magnitude of B and S are added or subtracted to give the in phase and out of phase images.

InPhaseImage=B+S=|I₁| (11)

OutOfPhaseImage=B−S (12)

B and S do not depend on the phase of I₁ and I₂ and hence the lack of sensitivity to phase. Note also that B+S is numerically equal to the magnitude of the in phase image I₁. This formulation may result in less signal-to-noise since the in-phase image is numerically identical to I₁ with no contribution from the out of phase image, I₂.

### Magnetic Field Reference Images

In the methods used by Xiang, the FSE data itself is used to determine two potential phase candidates denoted by Pu and Pv:

$$\begin{matrix}Pu = \frac{{C}_{2}}{B + S {e}^{i α}} & ( 13 ) \\ Pv = \frac{{C}_{2}}{S + B {e}^{i α}} & ( 14 )\end{matrix}$$

The phase of Pu or Pv represents the phase error created by the magnetic field, φₘ at any given point. However, it is ambiguous as to which phase candidate is the correct solution. Improper choice will result in fat assigned to the water image and water assigned to the fat image.

To resolve the ambiguity, Jiang exploits the fact that the magnetic field is slowly varying. By repeated application of a low pass filter and iterative refinement, Jiang is able to resolve the ambiguity for images presented therein.

However, Applicants have found that, for larger homogeneity errors and the presence of artifacts or low noise, this method breaks down. Hence Applicants have chosen not to use this method as the primary means of determining φₘ.

Rather, in accordance with a preferred embodiment of the invention, two magnetic field reference images are collected to create an estimate of the magnetic field error as a function of space. As with the FSE data, the first image is taken with the gradient echo and spin echo occurring at the same time. This causes a cancellation of any magnetic field/frequency offset errors resulting in an image with fat and water in phase. The second magnetic field reference image also taken with fat and water in phase; however, in this case the spin echo and the gradient echo are chosen such fat and water are separated by 360 degrees. Thus fat becomes aliased on top of water in the resultant image. A full 360 degree rotation between fat and water requires an echo time difference of 1/150=6.67 msec at 1.0 Tesla. The phase difference between the two images is then equal to the difference between the magnetic field and spectrometer center frequency to an integer multiple of 150 Hz. To obtain a full homogeneity map the phase map is unwrapped to resolve the ambiguity of the integer multiple of 2π shifts.

It will be appreciated by those of skill in the art that the approaches described herein are equally adaptable to any magnetic field conditions and strengths as appropriate. Specifically, while Examples are depicted herein produced using a background magnetic field of about 1.0 T, any stronger or weaker field may be used, such as 0.5 T, 1.5 T, 2.0 T, 2.5 T, 3.0 T, 3.5 T, 4.0 T, 5.0 T, 6.0 T and 7.0 T as well any suitable higher field.

The reference scans are preferably acquired using the same waveforms as in FIG. 1 except they are collected as a conventional spin echo (echo train of 1). The TR and TE of the reference scans are preferably kept as short as possible to keep scan time low.

In the exemplary disclosed imaging techniques described here, the reference images are acquired separately from the FSE scans. Separating the scans is advantageous for at least the following reasons:

(i) The processing of the reference images can be time consuming. Collecting all the information in advance of the FSE scans allows their processing in parallel with the FSE scans.

(ii) The reference scans and the FSE scans are not constrained to utilize the exact same timing, number of phase encode steps and echo times. This allows a greater flexibility in the choice of scan parameters for both scans. For example the TR and TE of the reference scans can be kept very short minimizing imaging time.

(iii) The disadvantage of separate reference scans is their use of time that could otherwise be used to obtain image information. If the time is kept to a minimum, the advantages noted above outweigh this disadvantage.

(iv) Another potential disadvantage of taking separate reference scans is small changes in homogeneity from the time of taking the reference scans to the time of collecting the FSE data (due to temperature drift of the shims or magnet), can result in a slowly varying phase error. Small drifts can be corrected by comparison of the reference scan results with the Pu and Pv result.

In the depicted example, the location of the reference scan planes are chosen to be at the same slice locations as the FSE scans. This is not strictly required and any scan plane orientation can be chosen as long as the overall imaging volume is adequately covered. This would require an additional interpolation step to obtain the phase at the desired pixel location.

In another variation, the reference image may be acquired at a lower resolution. This allows the reference scans to be acquired faster and with more SNR. In the example below the reference scans were acquired at a matrix size of 128×128 and the final image was acquired at a matrix size of 256×256.

### Phase Unwrapping the Magnetic Field

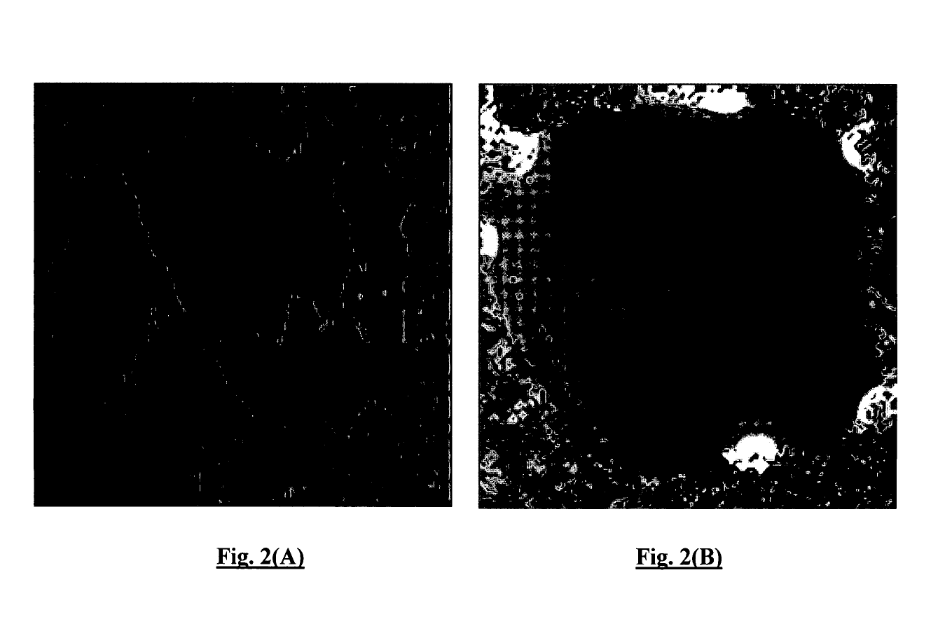

FIG. 2(A) depicts an example of the computed phase difference between the two reference images that is turned into a phase map image. The phase difference is preferably computed as the inverse tangent of the ratio of the cross product divided by the dot product according to:

$${φ}_{m} = {tan}^{- 1} ( \frac{{E}_{1} \times {E}_{2}}{{E}_{1} \cdot {E}_{2}} ) \qquad ( 15 )$$

wherein E₁ and B₂ are complex quantities (treated as 2D vector in Equation (8) that represent the 0 degree in-phase and 360 degree in-phase reference scans. The phase jumps in FIG. 1 are due to the magnetic field error which is aliased every 150 Hz (3.5 ppm) at 1.0 T main field. The phase varies from −π to π.

The process of phase unwrapping involves removal of 2π phase jumps by spatial integration of the phase. Errors in the integration can arise from noise or artifact. FIG. 2(B) is the phase map image after unwrapping. The intensity in the phase map image is proportional to the frequency at each pixel location. Although the depicted image is a sagittal image of the knee, very little tissue contrast can be seen in the image. In the unwrapped phase map image the varying bright/dark areas of the image are qualitatively recognized as a spherical harmonic solution of the type that is expected of a magnetic field solution.

### Phase Unwrapping Method

The spectrometer frequency may be set by the operator to place water near magnet center frequency (e.g., 42.58 MHz for 1.0 Tesla). Prior phase unwrapping typically begins by assuming the pixels closest to the center of the phase map image are not aliased and therefore represent the correct phase for water. In the simplest form of phase unwrapping, pixels are searched outward from center in spiral fashion until a large phase jump between adjacent pixels is encountered. An integer multiple of 2π is added or subtracted to the pixel further from center. This process is repeated until the entire phase map image is unwrapped.

However, this simple form of phase unwrapping is not robust in practice. A single pixel can have a large phase error which causes an incorrect assignment of the 2π phase jumps. Errors can then propagate to adjacent pixels causing a whole line or section of the phase map image to have an improper computation of fat and water. Areas of no signal result in completely erroneous results resulting in no way to jump across gaps.

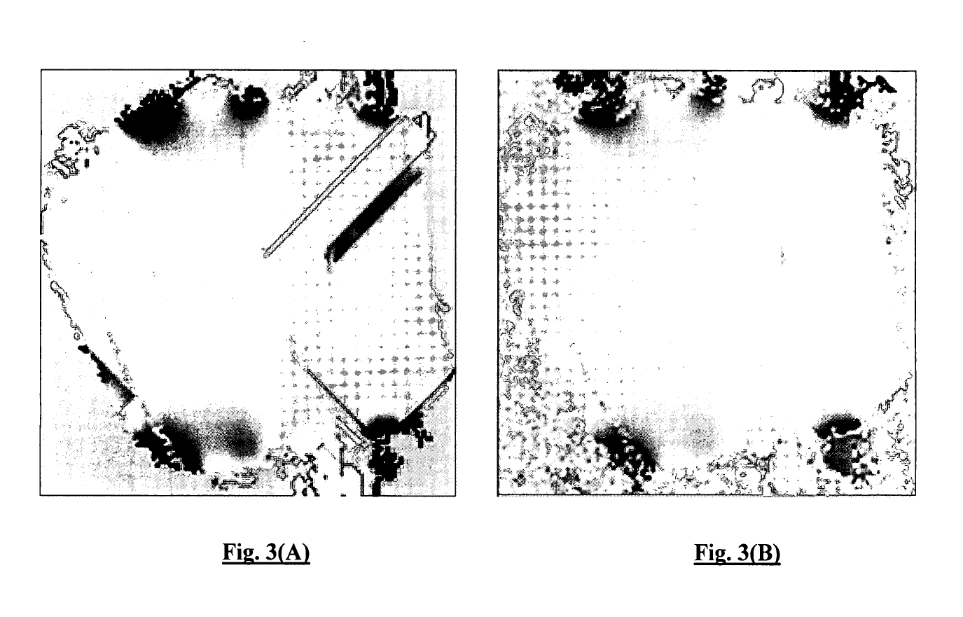

FIG. 3(A) depicts an example where this simple form of phase unwrapping was used. The border area in the phase map image of uniform intensity contains pixels below threshold (set at 4% of the amplitude of the 360 degree in-phase image). These “below threshold pixels” are ignored in the unwrapping process. The diagonal streaks were caused by single isolated pixel phase errors (in this case flow related) that propagate in a radial outward diagonal direction. The search method was a square spiral from image center. Errors propagate in a diagonal direction as the spiral diameter is increased.

In contrast, FIG. 3(B) depicts the same phase map image unwrapped using an improved technique provided in accordance with the invention and described below. The diagonal streaks that start from the interior of the image are eliminated. Both methods can have errors near the very edge but careful review of both phase maps shows the improved method has fewer failures near the edges and none in the interior of the phase map image.

A robust exemplary algorithm embodied in a software program was developed to unwrap a series of parallel phase map image slices. The steps and their order along with rationale are described in Table 1.

TABLE I
Exemplary Phase Unwrapping Steps

| Step # | Step to be performed | Rationale/Detail |
|---|---|---|
| 1 | Pixels to be unwrapped are identified | Unwrapping of noise is unnecessary, introduces |
| | by distinguishing very noisy pixels | possible errors (depending on the algorithm) |
| | containing no tissue from those pixels | and adds to the unwrapping time. A simple |
| | with tissue and therefore higher SNR. | method to separate noise pixels uses a threshold |
| | | on the image intensity. A more sophisticated |
| | | method is described below which allows |
| | | unwrapping into regions of relatively low SNR. |
| | | Details of this more sophisticated method are |
| | | described in the next section below. |
| 2 | Pixels marked for unwrapping are | The step value is a variable, typically chosen to |
| | grouped into continuously connected | be much smaller than π. By grouping in this |
| | groups where the phase difference | manner, areas of uniform magnetic field and |
| | between adjacent points is smaller | high SNR (low variation in phase) are |
| | than some predetermined step value. | associated with larger groups. Areas of lower |
| | | SNR or rapidly varying magnetic field tend to |
| | | be associated with smaller groups. |
| 3 | The numbers of border pixels for all | Border pixels are pixels where one of the most |
| | pairs of groups are computed. | immediate 8 pixels is from an adjacent group. |
| 4 | Groups are iteratively combined | Combining groups with largest numbers of |
| | where group pairs with largest | border pixels first have the statistical benefit of |
| | number of border pixels are | averaging a large number of adjacent pixels, |
| | combined first. The phase of points | minimizing the possibility of computing the |
| | in the group furthest from image | incorrect number of 2π jumps. Areas of more |
| | center is adjusted by integer 2π phase | uniform field and higher SNR are combined |
| | jumps to best match the phase of the | first. Smaller groups, relegated to lower SNR |
| | group nearer image center. The | and regions of rapidly changing magnetic field, |
| | integer is determined from the | are grouped last. This avoids propagation of |
| | average phase difference of all border | errors from single pixel or smaller groups. |
| | pixels associated with the two groups. | Errors, if any, in phase unwrapping are |
| | | therefore localized to small groups. |
| 5 | Pixels associated with isolated groups | This is analogous to the neighboring pixels |
| | are analyzed to determine the number | characterization in step (3) above except in this |
| | of nearby pixels that are less than | case groups can have gaps (such as areas of |
| | some distance (example: 20% of the | noise) by some fractional portion of the image |
| | image FOV). The average phase | FOV. |
| | difference between pixels is | |
| | calculated along the way. | |
| 6 | Isolated groups are iteratively | This is analogous to the neighboring pixels |
| | combined where those with the | characterization in step (4) above except in this |
| | greatest number of neighboring pixels | case groups can have gaps (such as areas of |
| | are combined first. The phase of the | noise or isolated tissue) by some fractional |
| | groups furthest from image center is | portion of the image FOV. |
| | adjusting by integer 2π jumps that | |
| | best match the average phase | |
| | between groups. | |
| 7 | Starting from the center slice and | By unwrapping from center all slices to the |
| | working outward in opposite slice | phase of the center portion of the center slice |
| | directions, compute the average | are referenced. The operator accurately sets the |
| | phase difference between points in | center frequency of the center slice during |
| | adjacent slices. Only consider | prescan portion of the image setup. |
| | adjacent point pairs that were | |
| | previously unwrapped in the slices. | |
| 8 | Iteratively adjust phase of points in | By using average of many points in adjacent |
| | slice furthest from center slice by | slices we have the statistical benefit of |
| | integer 2π jumps to best match | averaging a large number of points. |
| | average phase difference between | |
| | slices. | |

### Identification of Pixels to be Unwrapped

Identification of pixels to be unwrapped is advantageous to prevent the algorithm from consuming excessive computation time unwrapping noise. An exemplary regrouping algorithm, as described here, takes N squared computation time where N is the number of groups. Unwrapping noisy pixels can result in a large number of small (e.g., as little as 1 pixel per group) groups resulting in prohibitively long computing time (e.g., many minutes for a single slice). A simple threshold does a good job of identifying most pixels but determining an accurate threshold is difficult. If the threshold is set too low, computation time can be too long. If the threshold is set too high many pixels that could have been unwrapped are missed.

Unwrapping near the noise limit is especially advantageous near the edges of the image where the magnetic field is changing rapidly. The 360 degree in-phase reference image can have significant SNR loss due to dephasing within a pixel yet the signal in the FSE image data is not completely lost and a useful image data can be obtained if the unwrapping is accurate in this region.

Having considered the effect of the loss of signal intensity in the 360 degree in-phase reference image and the desire to unwrap the phase map as far as possible into the noise without actually unwrapping all noise pixels, we arrive at an approach that works better than an amplitude threshold as illustrated below in Table 2. This exemplary approach greatly reduces the sensitivity to any threshold setting and allows unwrapping of pixels below the threshold so long as these pixels are continuously connected to ones above the threshold.

TABLE II
Exemplary Steps to Identify Pixels to be Unwrapped

| Step # | Step to be performed | Rational/Detail |
|---|---|---|
| 1 | All pixels are grouped into | This is the same as in step (2) of the phase |
| | continuously connected groups where | unwrapping process as described in Table I, |
| | the phase difference between adjacent | however, in this case all pixels are preferably |
| | pixels is smaller than some | considered. |
| | predetermined step value (typically | |
| | much less than π). | |
| 2 | The size of each group and the | The step value is a variable, typically chosen to |
| | number of pixels in each group above | be much smaller than π. By grouping in this |
| | an intensity threshold is computed. | manner, areas of uniform magnetic field and |
| | | high SNR (low variation in phase) are |
| | | combined into larger groups and areas of lower |
| | | SNR or rapidly varying magnetic field are |
| | | isolated to smaller groups. |
| 3 | Pixels associated with very small | If the group is small and none of the pixels are |
| | groups (example < 5) where all | above the threshold, the pixels are likely noise |
| | points in group are below the | or artifact. If on the other hand if the group is |
| | threshold are flagged so no attempts | small and one of the pixels is above threshold |
| | to unwrap these pixels are made. | these pixels should be unwrapped. Unwrapping |
| | | a few noise pixels by mistake does not add |
| | | significant time. |
| 4 | If the number of groups exceed a | Large number of groups to be unwrapped can |
| | preset value, increase the threshold | result in excessive computation time. This |
| | by factor of 2 and go back to step 1 | usually occurs when the threshold is too low or |
| | otherwise continue with the | the images are all noise. This step dynamically |
| | unwrapping process. | adjusts the threshold to compensate and keeps |
| | | the computation bounded. |

As a further embodiment, it is possible to reduce the pixel size of the 360 degree in-phase reference images to reduce the sensitivity of dephasing effects due to the field inhomogeneity. This improvement is most notable in the slice direction because it is typically the largest of the 3 dimensions. The reduced pixel size can reduce the SNR of the reference images; however, this has minimal impact on the SNR of the final scan.

Unwrapping near the noise limit is especially important near the edges of the image where the magnetic field is changing rapidly. The 360 degree in-phase reference image can have significant SNR loss due to dephasing within a pixel yet the signal in the FSE image data is not completely lost and a useful image data can be obtained if the unwrapping is accurate in this region.

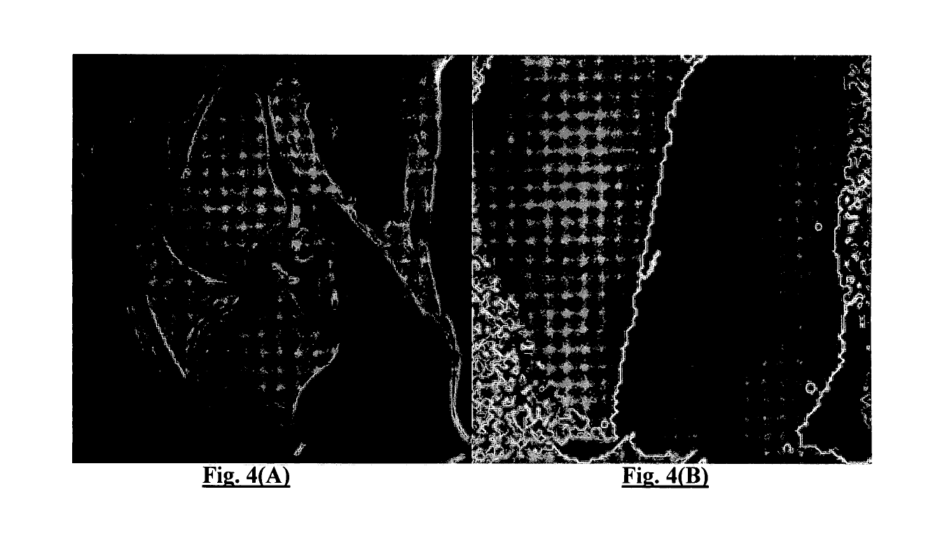

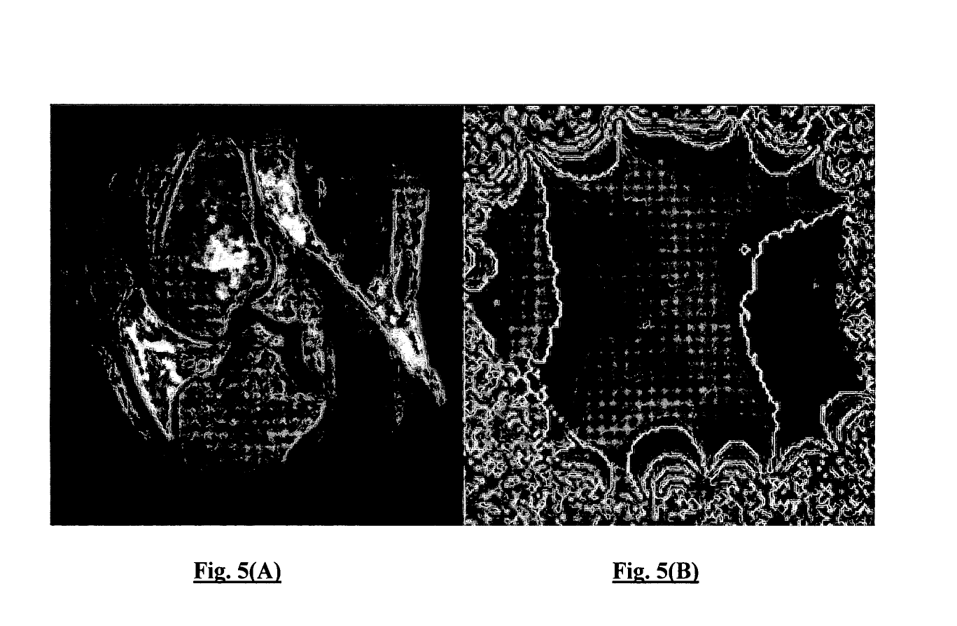

FIG. 4 depicts the 0 degree in-phase and FIG. 5 depicts the 360 degree in-phase reference image corresponding to the phase map of FIG. 2. As depicted, the in-phase reference image is relatively unaffected by the magnet homogeneity due to the fact that the gradient echoes are timed to coincide the spin echoes. However, the 360 in-phase reference image has significant signal loss in areas of rapidly changing magnetic field as shown near the top and bottom edges of the image.

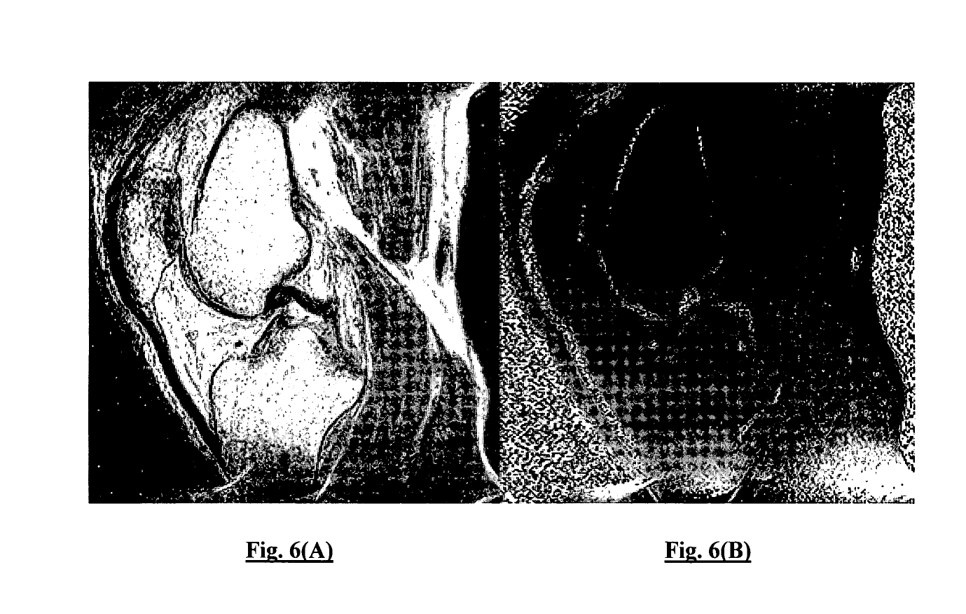

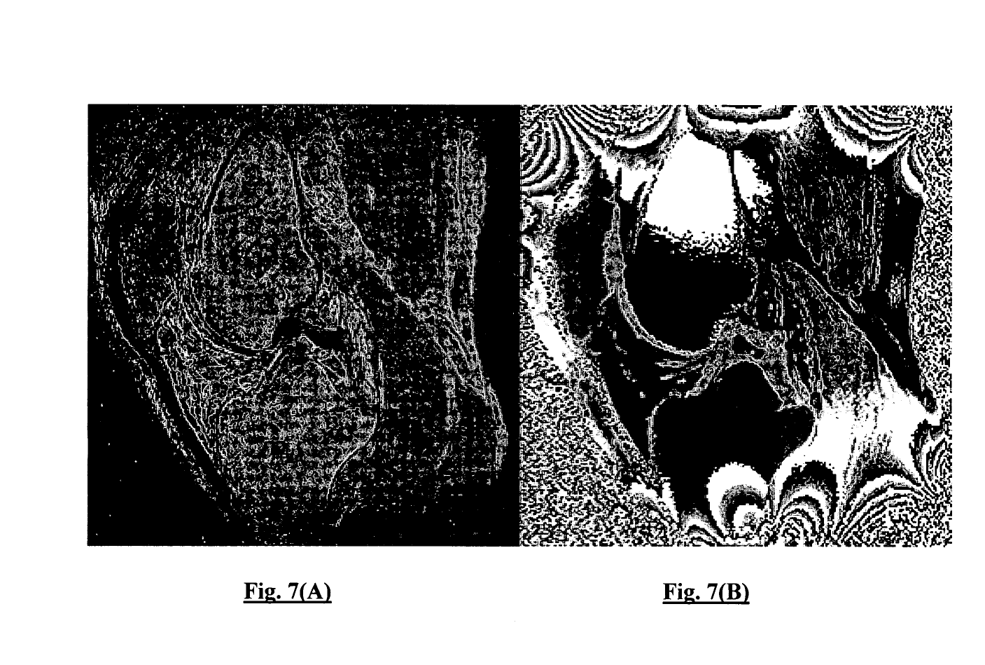

FIG. 6 and FIG. 7 depict the respective associated FSE scans. Note that like the reference image, the in phase FSE data is relatively unaffected by the shim. The out-of-phase FSE image, taken with 135 degree phase difference, has reduced signal intensity at the edges by not as great as the 360 degree reference image hence the desire to utilize to unwrap the reference data phase map as far as possible.

The phase reference images are collected at reduced resolution relative to the final image resolution. This is done to save phase unwrapping time. Note that the magnetic field varies slowly as compared to the resolution in most of the image so collecting more detailed phase map will not improve the image much but can add significant time to the computation.

Once the phase map image is unwrapped at lower resolution, it is interpolated to the final image matrix size. This is preferably done by bi-cubic magnification with a subsequent application of 2D Gaussian filter applied. The Gaussian filter reduces very subtle ringing in the phase map that would otherwise be observed in the water image but is not visible in the stronger fat image. The Gaussian filter implementation has a 3 point kernel. Two passes are applied making the net result a 5 point filter.

In the exemplary implementation described herein, the location of the reference scan planes are chosen to be at the same slice locations as the FSE scans. This is not strictly required and any scan plane orientation can be chosen as long as the overall imaging volume is adequately covered. This would require an additional interpolation step to obtain the phase at the desired pixel location.

The time between acquisition of the reference scans to the collection of the FSE data can be a few minutes. During this time small changes in shim (due to temperature drift of the shims or magnet), can result in a slowly varying phase error in the value of φₘ which in turn can result in a small amount of increased intensity in the fat suppressed image. In the exemplary implementation herein we compare the value of φₘ computed from the field map images with the phase of Pu and Pv computed from the FSE scans and choose the value of Pu or Pv that is a best match. This corrects for small drifts in shim and results in a more uniform fat suppression.

### Exemplary Image Reconstruction Steps

Below is summary of exemplary illustrative reconstruction steps using as input the raw FSE data and the and the unmapped phase map.

TABLE III
Exemplary Reconstruction Steps

| Step # | Step to be performed | Rational/Detail |
|---|---|---|
| 1 | Reconstruct the in-phase and out-of- | The in-phase and out-of-phase FSE images |
| | phase FSE images yielding I1 and I2. | are line by line phase-corrected; Fourier |
| | | transformed and over sampling removed. |
| 2 | Obtain the Pu and Pv Phase candidates | The value of Pu or Pv closet to the phase map |
| | using Equation 13 and 14 and compare | is chosen as the phase map value. |
| | with the phase map as computed using | |
| | the methods described in Table 1. | |
| | Adjust the phase map to match Pu and | |
| | Pv. | |
| 3 | Smooth the resultant phase map | Step 2 can result in noisy values for the phase |
| | | map. Smoothing reduces this phase noise |
| | | introduced by this step. 2 passes of a 5 point |
| | | Gaussian filter works well. |
| 4 | Repeat steps 2 and 3 depending on | This mimics the iterative smoothing done by |
| | recon function input variables. | Jiang. Current implementation uses only one |
| | | pass with no iterative correction. |
| 5 | Compute B and S from Equation 9 and | Needed for in-phase and out-of-phase image |
| | Equation 10 | results |
| 6 | Compute water and fat image from | |
| | Equation 8. | |
| 7 | Compute in-phase and out-of-phase | Using B and S versus the water and fat results |
| | image results(not to be confused with | minimizes edge artifacts in locations of failed |
| | FSE in phase and FSE out-of-phase | phase map results. |
| | image input) using equation 11 and 12 | |
| 8 | Convert the water, fat, in-phase and | The floating point complex results need to be |
| | out-of-phase to final format | converted to integer magnitude images or |
| | | other format as describe by the pulse sequence |
| | | input. Note that gradient distortion correction |
| | | is not done in this recon function. |

### Exemplary Image Results

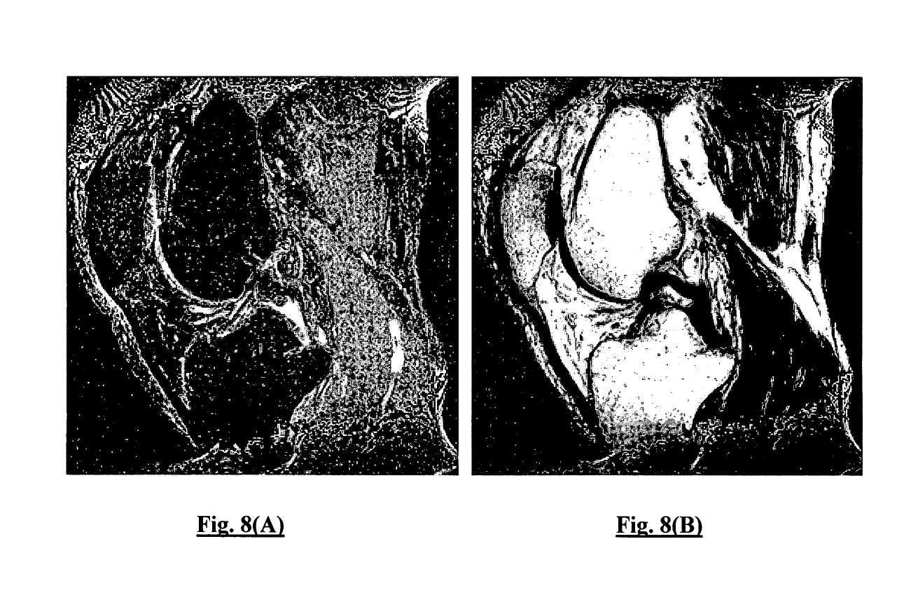

FIG. 8 below depicts exemplary fat and water image results. The reference images were acquired at a matrix of 128×128 and converted into a phase map according to Equation (8). The phase map (FIG. 2a) was then unwrapped (FIG. 2(B)) using the exemplary steps outlined in Table I. The step for grouping was π/10. The identification of pixels to be unwrapped utilized the methods outlined in Table 2 with a threshold of 4%. Pixels associated with groups of 4 or less points, where none of the points are above the threshold, were not unwrapped. The unwrapped phase map was then interpolated to the size of the final FSE image (256×256 pixels in this case) using bi-cubic interpolation. The associated in-phase and out-of-phase reconstructed FSE scans were phase corrected using Equation 5 and 6 yielding the phase corrected images C1 and C2. C1 and C2 and Equation 8 were then used to create the Fat and Water images. The results are given in FIG. 8.

The depicted images acquired are not exceptionally high SNR, yet the unwrapping and fat/water separation works very well. In this example, the images degrade in quality proximate the edges where the phase map information is no longer valid due to the extremely rapidly changing magnetic field.

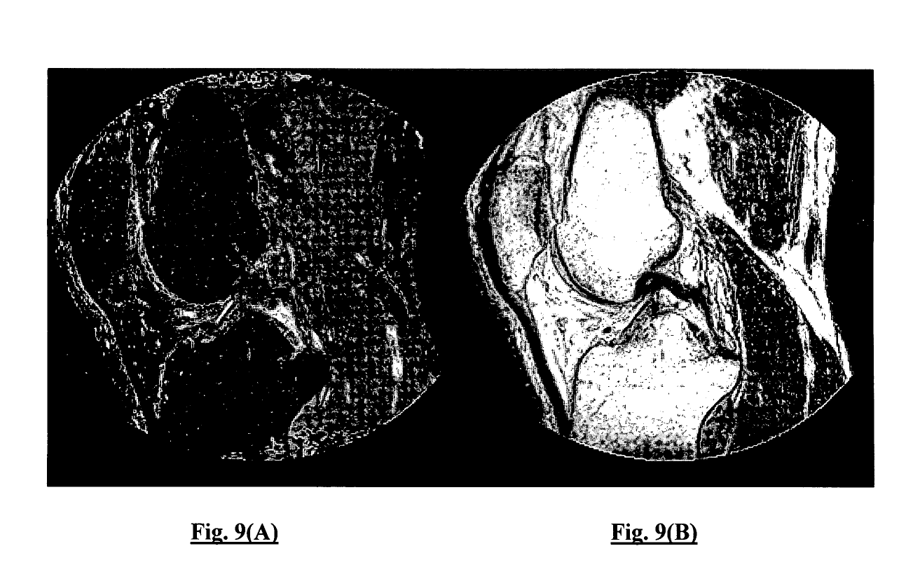

The magnetic field solutions naturally result in a homogeneous volume that is ellipsoidal in shape. This matches the vacuum magnetic field solutions, which in turn are combinations of spherical harmonics. The maximum use of this volume requires imaging fields of view that have dimensions on the same scale as the homogeneous volume. The magnet homogeneity deteriorates rapidly beyond a ellipsoidal volume with 14 cm diameter axial by 16 cm diameter radial, outside of which the image quality is generally not considered diagnostically useful. Therefore the final images are masked outside this volume. The resultant masked fat and water images are shown in FIG. 9. The offset of the mask is a result of offset in the graphic prescription of the scans.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Exemplary description of the steps of techniques illustrated herein also represent illustrative steps that may be carried out automatically by imaging systems and/or associated computer systems and software. Thus the functions of the various steps depicted herein may be provided through the use of dedicated hardware as well as hardware capable of executing software in association with appropriate software. When provided by a processor, the functions may be provided by a single dedicated processor, by a single shared processor, or by a plurality of individual processors, some of which may be shared. The functions of those various elements may be implemented by, for example, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Similarly, it will be appreciated that the system flows described herein represent various processes which may be substantially represented in computer-readable medium and so executed by a computer or processor, whether or not such computer or processor is explicitly shown. Moreover, the various processes can be understood as representing not only processing and/or other functions but, alternatively, as blocks of program code that carry out such processing or functions.

It will be further appreciated that the system of the present invention may include any suitable MRI system adapted and configured to operate using any of the techniques embodied herein.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The recitation of method steps herein represent conceptual disclosures of illustrative software embodying the principles of the invention. Thus the functions of the various elements shown in the Figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. The functions of those various elements may be implemented by, for example, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent to those shown herein.

Similarly, it will be appreciated that the illustrated embodiments described herein represent various processes which may be substantially represented in computer-readable medium and so executed by a computer or processor, whether or not such computer or processor is explicitly shown. Moreover, the various processes can be understood as representing not only processing and/or other functions but, alternatively, as blocks of program code that carry out such processing or functions.

The methods and systems of the present invention, as described above and shown in the drawings, provide for imaging techniques with superior attributes compared to those of the prior art. It will be recognized that the exemplary techniques depicted herein may be carried out using all of the illustrated steps, or additional or fewer steps than depicted. Moreover, it will be recognized that the steps may be carried out in any order as this disclosure is intended to be merely illustrative, and not limiting nor exhaustive. It will be apparent to those skilled in the art that various modifications and variations can be made in the system and method and software program of the present invention without departing from the spirit or scope of the invention. Thus, it is intended that the present invention include modifications and variations that are within the scope of the subject disclosure and equivalents.

What is claimed is:

1. A method of collecting magnetic resonance images, comprising:
a) collecting at least one reference scan with respect to a region of interest;
b) collecting at least one imaging scan with respect to the region of interest;
c) analyzing the at least one reference scan to determine the inhomogeneity of the transmit field; and
d) adjusting the at least one imaging scan to account for the inhomogeneity of the transmit field to form a final image.

2. The method of claim 1, wherein:
a) a plurality of reference scans are collected with respect to the region of interest;
b) a plurality of imaging scans are collected with respect to the region of interest;
c) the plurality of reference scans are analyzed to determine the inhomogeneity of the transmit field; and
d) the imaging scans are adjusted to account for inhomogeneity of the transmit field to form the final image.

3. The method of claim 2, wherein the plurality of reference scans are collected prior to the plurality of imaging scans.

4. The method of claim 2, wherein the plurality of reference scans do not constitute part of the final image.

5. The method of claim 2, wherein the reference images are used to obtain a map of transmit field inhomogeneity.

6. The method of claim 2, wherein the phase difference due to field inhomogeneities are removed using information from the reference scans.

7. The method of claim 2, wherein a first reference scan is performed with the gradient echo and the spin echo occurring at substantially the same time.

8. The method of claim 7, wherein a second reference scan is also performed with the gradient echo and the spin echo occurring at substantially the same time.

9. The method of claim 2, wherein the imaging scans are used to create separate images of fat and water in the region of interest.

10. The method of claim 9, wherein the separate images of fat and water are created by adjusting the imaging scans on a pixel by pixel basis.

11. The method of claim 2, wherein the plurality of imaging scans are collected using a fast spin echo sequence.

12. The method of claim 2, wherein a first imaging scan is collected with fat and water in-phase, and a second image is collected with fat and water out of phase by a predetermined amount.

13. The method of claim 12 wherein an image relating to the first imaging scan is created by collecting the gradient echo at the spin echo time when the chemical shift between the fat and water are substantially refocused.

14. The method of claim 12 wherein an image relating to the second imaging scan is created by collecting the gradient echo at a time misaligning to the spin echo.

15. The method of claim 13, wherein the spin echo and gradient echo are chosen such that fat and water are separated in phase by about 360 degrees.

16. The method of claim 1, wherein the images are collected in a background magnetic field between about 0.5 T and about 7.0 T.

17. The method of claim 2, wherein the images are collected in a background magnetic field between about 1.5 T and about 5.0 T.

18. The method of claim 2, wherein the images are collected in a background magnetic field between about 3.0 T and about 4.0 T.

19. The method of claim 2, wherein the reference scans are processed in parallel with the imaging scans.

20. The method of claim 2, wherein the reference scans and imaging scans do not use the same timing.

21. The method of claim 2, wherein the reference scans and imaging scans do not use the same number of phase encode steps.

22. The method of claim 2, wherein the reference scans and imaging scans do not use the same echo times.

23. The method of claim 2, wherein the computed phase difference between two images obtained by way of the reference scans is used to create a phase map image.

24. A method of performing phase unwrapping, comprising:
a) identifying a plurality of pixels in a slice containing tissue to be unwrapped by distinguishing pixels containing substantially no tissue from pixels containing tissue;
b) sorting the identified pixels in the slice into groups of pixels;
c) computing the numbers of border pixels for each of the groups of pixels;
d) iteratively combining the groups of pixels in the slice;
e) adjusting the phase of pixels in groups furthest from the image center to comport with the phase of pixels proximate the image center;
f) computing the average phase difference between locations in adjacent slices, beginning from the center slice and working outward in opposite slice directions; and
g) iteratively adjusting the phase of points in slices furthest from center slice to match average phase difference between slices.

25. The method of claim 24, wherein pixels containing substantially no tissue are distinguished from pixels containing tissue by setting a threshold on image intensity.

26. The method of claim 24, wherein the sorting step includes sorting the identified pixels in the slice into groups of pixels based on at least one of (i) the uniformity of magnetic field in the region of the pixel, and (ii) the strength of signal to noise ratio in the region of the pixel.

27. The method of claim 24, wherein the sorting step includes sorting the identified pixels in the slice into groups of continuously connected pixels.

28. The method of claim 27, wherein the size of each group of continuously connected pixels and the number of pixels in each such group above an intensity threshold is computed.

29. The method of claim 28, wherein pixels are not processed in groups where each pixel in the group is below the intensity threshold.

30. The method of claim 28, wherein the threshold is increased if the number of groups of pixels exceeds a preset value.

31. The method of claim 27, wherein the phase difference between adjacent pixels is smaller than a predetermined step value.

32. The method of claim 24, wherein border pixels include pixels wherein one of the nearest 8 pixels to the subject pixel is from an adjacent group of pixels.

33. The method of claim 24, wherein pairs of the pixel groups with the largest number of border pixels are combined prior to other pairs of pixel groups.

34. The method of claim 25, wherein pixels associated with substantially isolated groups of pixels are analyzed to determine the number of tissue-containing pixels that are within a predetermined distance from the pixels associated with the substantially isolated groups.

35. The method of claim 34, wherein the predetermined distance is a dimension relating to about 20% of the image field of view.

36. The method of claim 34, wherein the substantially isolated groups of pixels are iteratively combined.

37. The method of claim 36, wherein isolated pixels with the greatest number of neighboring pixels are combined first.

38. A system for collecting magnetic resonance images, comprising:
a) means for collecting at least one reference scan with respect to a region of interest;
b) means for collecting at least one imaging scan with respect to the region of interest;
c) means for analyzing the at least one reference scan to determine the inhomogeneity of the transmit field; and
d) means for adjusting the at least one imaging scan to account for the inhomogeneity of the transmit field to form a final image.

39. A system for collecting magnetic resonance images, comprising:
a) means for collecting a plurality of reference scans with respect to a region of interest;
b) means for collecting a plurality of imaging scans with respect to the region of interest;
c) means for analyzing the plurality of reference scans to determine the inhomogeneity of the transmit field; and
d) means for adjusting the imaging scans to account for inhomogeneity of the transmit field to form a final image.

40. A system for performing phase unwrapping, comprising:
a) means for identifying a plurality of pixels in a slice containing tissue to be unwrapped by distinguishing pixels containing substantially no tissue from pixels containing tissue;
b) means for sorting the identified pixels in the slice into groups of pixels;
c) means for computing the numbers of border pixels for each of the groups of pixels;
d) means for iteratively combining the groups of pixels in the slice;
e) means for adjusting the phase of pixels in groups furthest from the image center to comport with the phase of pixels proximate the image center;
f) means for computing the average phase difference between locations in adjacent slices, beginning from the center slice and working outward in opposite slice directions; and
g) means for iteratively adjusting the phase of points in slices furthest from center slice to match average phase difference between slices.

41. A machine readable program on a computer readable medium containing instructions for controlling a system for collecting magnetic resonance images, the program comprising:
a) a first computer code segment for collecting at least one reference scan with respect to a region of interest;
b) a second computer code segment for collecting at least one imaging scan with respect to the region of interest;
c) a third computer code segment for analyzing the at least one reference scan to determine the inhomogeneity of the transmit field; and
d) a fourth computer code segment for adjusting the at least one imaging scan to account for the inhomogeneity of the transmit field to form a final image.

42. A machine readable program on a computer readable medium containing instructions for controlling a system for collecting magnetic resonance images, the program comprising:
a) a first computer code segment for collecting a plurality of reference scans with respect to a region of interest;
b) a second computer code segment for collecting a plurality of imaging scans with respect to the region of interest;
c) a third computer code segment for analyzing the plurality of reference scans to determine the inhomogeneity of the transmit field; and
d) a fourth computer code segment for adjusting the imaging scans to account for inhomogeneity of the transmit field to form a final image.

43. A machine readable program on a computer readable medium containing instructions for controlling a system for performing phase unwrapping, the program comprising:
a) a first computer code segment for identifying a plurality of pixels in a slice containing tissue to be unwrapped by distinguishing pixels containing substantially no tissue from pixels containing tissue;
b) a second computer code segment for sorting the identified pixels in the slice into groups of pixels;
c) a third computer code segment for computing the numbers of border pixels for each of the groups of pixels;
d) a fourth computer code segment for iteratively combining the groups of pixels in the slice;
e) a fifth computer code segment for adjusting the phase of pixels in groups furthest from the image center to comport with the phase of pixels proximate the image center;
f) a sixth computer code segment for computing the average phase difference between locations in adjacent slices, beginning from the center slice and working outward in opposite slice directions; and
g) a seventh computer code segment for iteratively adjusting the phase of points in slices furthest from center slice to match average phase difference between slices.
